(19) United States
(12) Patent Application Publication
(10) Pub. No.: US 2013/0113814 A1
(43) Pub. Date: May 9, 2013

(54) Matching Based on a Created Image

(71) Applicant: KLEA, Inc., San Diego, CA (US)

(72) Inventor: Karen Howard, La Jolla, CA (US)

(73) Assignee: KLEA, INC., San Diego, CA (US)

(21) Appl. No.: 13/658,641

(22) Filed: Oct. 23, 2012

Related U.S. Application Data
(60) Provisional application No. 61/556,009, filed on Nov. 4, 2011.

(51) Int. Cl. G06T 7/00

(52) U.S. Cl. CPC G06T 7/00
USPC 345/522

(57) ABSTRACT

A method of matching based on a created image is provided. This method includes permitting a user to review and select a plurality of feature parts from a database located in a memory containing feature parts. A created image is generated based on the plurality of feature parts selected by the user. The created image is compared with real images of other users. A set of real images similar to the created image is determined. The set of real images is displayed to the user on a user device.

### CROSS REFERENCE TO RELATED APPLICATION

This patent document claims priority to Provisional Patent Application No. 61/556,009 filed Nov. 4, 2011, which is incorporated herein by reference in its entirety.

### BACKGROUND

Most dating websites rely upon profile descriptions of their users to perform the service of matching their subscribers to members of their site. Typically, dating websites suggest that users create a written profile, attach a photo of themselves, and a software engine automatically searches for matches based on words conveyed in the user's written profile. Alternatively, a dating website user may create a written profile and then manually build a custom query for searching. The search is used for the dating website database to find user profiles matching or substantially matching the custom query parameters.

It is known in the art to provide dating websites that permit users to find people who look similar to a particular, desired person. The user can submit a photograph of a person and request that the system search and then return a listing of user pictures which are similar to the desired person. The system does this by searching the faces of users of the online dating website and determining users who have faces that are perceptually similar to the photograph submitted.

Alternatively, a person may search through a database of images on the online dating service and find an image of someone who the user finds desirable. The system then may search and locate users with faces that look similar to the desirable face chosen by the user. Typically, the dating sites implementing these technologies utilize face matching and rely upon face mapping and vector analysis to match a real photograph or image of a person of interest with other real images of other users on the website.

Other online dating websites prompt a user to enter profile information, including a picture of the user's face. These systems then store the picture in a database of stored images. The system then prompts the user to enter a textual description of one or more desired characteristics. Next, the user is prompted to provide a query image of a face by uploading an image or by selecting an image from stored images or from selecting an image on the internet. The query image is of a face of a person that user finds desirable. The user is then prompted to indicate a preference for one or more facial features of the query image. The system then searches and compares the desired facial features with other user images in a stored image database and displays a listing of images. This is done by computing a difference vector between the query image features and the features of each of the other user images.

Avatars are common in the gaming industry, allowing users to create visual representations of their persona inside a game. There are gaming software applications that permit a user to create an avatar by allowing the user to upload an image and request that the software generate the avatar based on specific features of the image. These systems often use face mapping and vector analysis, then allow the user to modify specific facial or body features of the avatar created to suit their preferences. Other gaming sites permit users to use tools to build an avatar from scratch, so that the users select specific facial and body features to generate the avatar.

### SUMMARY

A method of matching based on a created image is provided. This method includes permitting a user to review and select a plurality of feature parts from a database located in a memory containing feature parts. A created image is generated based on the plurality of feature parts selected by the user. The created image is compared with real images of other users. A set of real images similar to the created image is determined. The set of real images is displayed to the user on a user device.

The present invention is better understood upon consideration of the detailed description below in conjunction with the accompanying drawings and claims.

### DESCRIPTION OF DRAWINGS

FIG. 1 is a process flowchart for the method of matching which is based on a created image;

FIG. 2 depicts an embodiment of a home page for the present invention;

FIG. 3 is an overview process flowchart for an embodiment of the build from scratch module;

FIG. 4 illustrates an embodiment of the build from scratch option's web-page;

FIG. 5 shows the overview process flowchart for an embodiment of the build from scratch feature;

FIG. 6 depicts an embodiment of the everyday match feature for the present invention;

FIG. 7 illustrates a flowchart for an overview for the everyday match feature;

FIG. 8 is a process flowchart for an embodiment the everyday match option;

FIG. 9 illustrates an embodiment of the celebrity match feature;

FIG. 10 depicts a process flowchart for an embodiment utilizing the celebrity match feature;

FIG. 11 details an embodiment of a mobile application for an image upload feature;

FIG. 12 shows an embodiment of the dashboard for the matching module;

FIG. 13 depicts an example of social posting;

FIG. 14 shows an embodiment of a sitemap for the website;

FIG. 15 is a diagram of an example process for creating a dream image;

FIG. 16 illustrates an embodiment of the hardware configuration supporting the website;

FIG. 17 depicts example subscription service plans;

FIG. 18 shows one embodiment of a detailed view of a member match; and

FIG. 19 is a process flowchart for the alternate embodiment of matching lifelike images to feature parts.

### DETAILED DESCRIPTION

The present invention is a method of matching lifelike (e.g., avatar) images to real images. In one embodiment of the present invention, a user builds a near-lifelike image of a person of interest by first selecting a base facial structure from a library located in a memory of available facial features. This memory is located remotely. Then, the user customizes the lifelike image by selecting a plurality of feature parts associated with parts of the human body such as a human face, clothing, or human upper body parts. A database is created to store the feature parts in a memory which is also located remotely. Simultaneously, while a user is selecting the plurality of feature parts, a dream builder software engine generates a preview image. The preview image may be displayed to the user on a user device during feature parts selection to assist with creating the desired image.

After the user has completed a desired image, the user may make a request for matching. The created image is then compared with real images of other users of the website to generate a set of real images of the other users, which are similar to the created image. The set of real images of other users is then displayed to the user on a user device.

In one embodiment, social networking tools are provided to allow users to engage in social activities after creating the near-lifelike image of a person of their dreams including facilitating the user to publish the created image to an external source such as a social networking website. While the embodiments are described using a website, a mobile application or other social media may be utilized for the present invention.

The method also permits the user to review and select additional feature parts from the database. These additional feature parts are stored in a memory and displayed on a user device. A second created image is generated based on the additional feature parts selected by the user then the second created image is compared with the real images of other users. A second set of real images similar to the second created image is determined and displayed to the user on the user device.

A method of matching based on a created image is also disclosed herein. The method comprises providing a database to store in a memory a plurality of graphically created feature parts. The memory is located remotely. The method permits a user to review the plurality of graphically created feature parts while the created feature parts are displayed on a user device, receives an input from the user indicating a desired set of the feature parts, generates a created image based on the desired set of the feature parts selected by the user, compares the created image with real images of other users, determines a set of real images similar to the created image, and displays the set of real images to the user on a user device.

In one embodiment, the matching of the near-lifelike image of a dream person to a real person may be provided by a game-like user interface. The image creating module provides a library (aka database) of graphically-created, virtual, near-lifelike people having interchangeable body parts/features that may be altered based on the user's preferences.

In another embodiment, the method of matching based on a created image further comprises receiving an image of a person, deconstructing the image of a person into a plurality of real feature parts, and using the real feature parts as inputs for making the graphically created feature parts.

Various terms are used throughout the description and are not provided to limit the invention. For example, the terms “dream-date”, “dream”, and “variation” refer to a near-lifelike image of a person that the user is attracted to or desires for dating/meeting purposes. The terms “feature category” and “feature type” refer to a high level description of a feature part (e.g., hair length, eye color, nose size, etc.).

These and other features will now be described with reference to the drawings summarized below. These drawings and associated description are provided to illustrate an embodiment of the invention, and not to limit the scope of the invention. Although the specific embodiments described a dating website, other types of applications are applicable, including searching for specific item of interest online, such as clothing, shoes, accessories, homes, furniture, pets, etc.

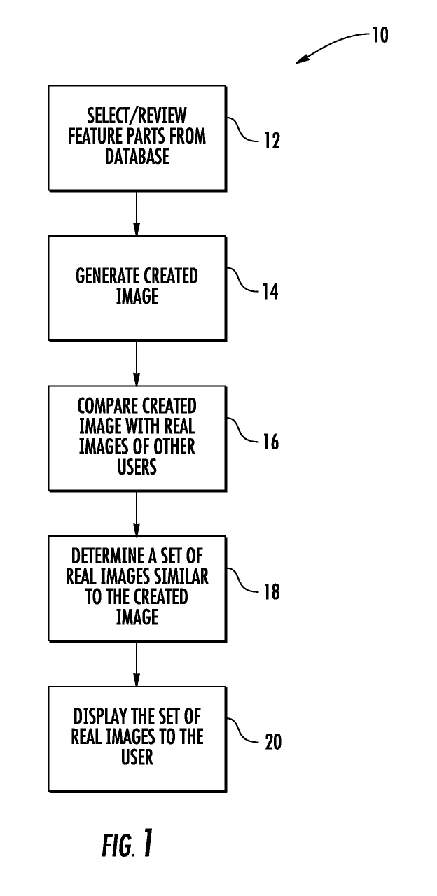

FIG. 1 is a process flowchart for the method of matching based on a created image 10. The process starts at step 12, where a user reviews and selects a plurality of feature parts from a database located in a memory containing feature parts. At step 14, a created image is generated based on the plurality of feature parts selected by the user. The created image is compared with real images of other users at step 16. At step 18, a set of real images similar to the created image is determined. The set of real images is displayed to the user on a user device at step 20.

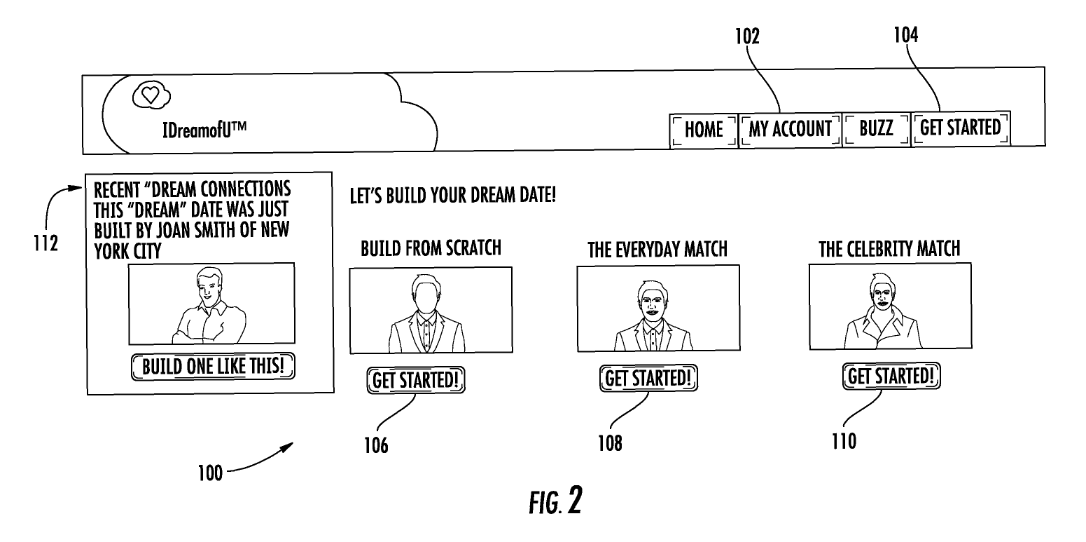

FIG. 2 depicts an embodiment of a home page 100 available on a website which permits a user of the site to visually create their dream image. A user of the site may choose to build a dream image from scratch 106 by selecting a baseline facial structure and then selecting feature parts to be merged into a single image. A database may be created to store the feature parts in a memory. In one embodiment, the memory is located remotely. Alternatively, a user of the site may utilize the everyday match feature 108. In this mode, the user may rely on a template image provided and then alter the image to the extent preferred by selecting different feature parts than those already predetermined by the template image. Alternatively, a user of the site may utilize the celebrity match feature 110 and select a near-lifelike image of a celebrity and optionally alter that image to the desired extent by selecting different feature parts than those provided by the near-lifelike image of a celebrity. Alternatively, a user of the site may utilize the recent dream connections feature 112. In this mode, the user may rely on a previously created image by another user then optionally alter the image to the extent preferred by selecting different feature parts than those already established. Other functionality available on the site may include the my-account feature 102 to permit a user to review their account detail. Added functionality such as the get-started tab 104 may permit a user to become a member or join to engage in social aspects of the invention.

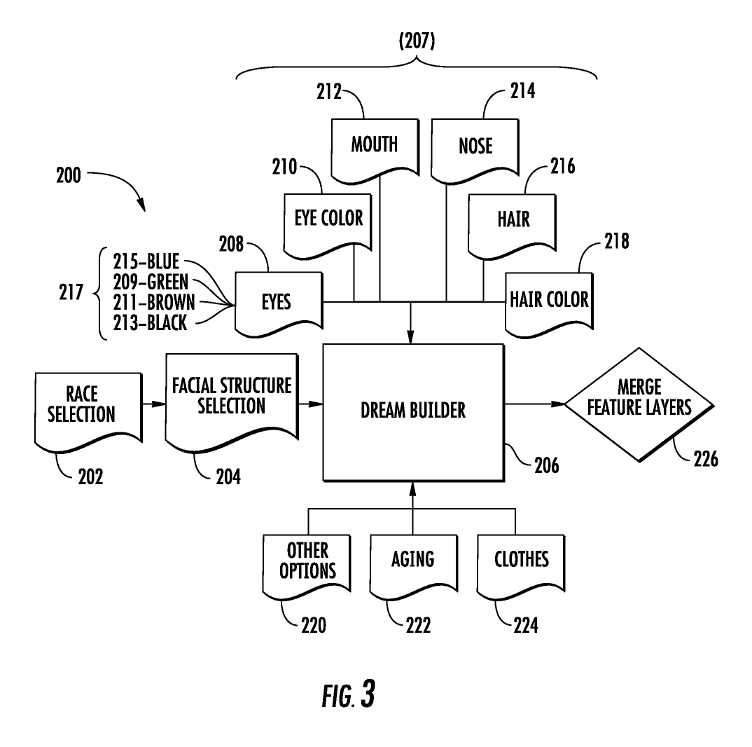

FIG. 3 is an overview process flowchart for an embodiment of the build from scratch module. In this embodiment, a user is permitted to create a person of their dreams by utilizing a predefined step-by-step process on the website. The user is permitted to review and select a plurality of feature parts from a database from a memory which is located remotely containing feature parts. The process 200 begins by allowing a user to select a race at step 202. The user then selects a facial structure at step 204. At step 206 a dream builder module allows the user to select from multiple feature categories 207 including eyes 208, eye color 210, mouth 212, nose 214, hair 216, hair color 218, age 222, clothes 224, or other options 220. The user may select feature parts 217 per feature category 207 as well. Each feature category 207 has a plurality of feature parts 217, as depicted in detail for eyes 208 as, for example, green eyes 209, brown eyes 211, black eyes 213, or blue eyes 215.

The user selection of feature parts 217 is then processed by the dream builder at step 206 for computational analysis. Lastly, at step 226, the merge feature layers module outputs a preview image, which incorporates all the selections for the feature categories 207 and the specific feature parts 217. The created image generated is based upon the plurality of feature parts selected by the user. The preview image may represent the final image of the user's dream image, which the user has created using this step-by-step process of building a dream from scratch.

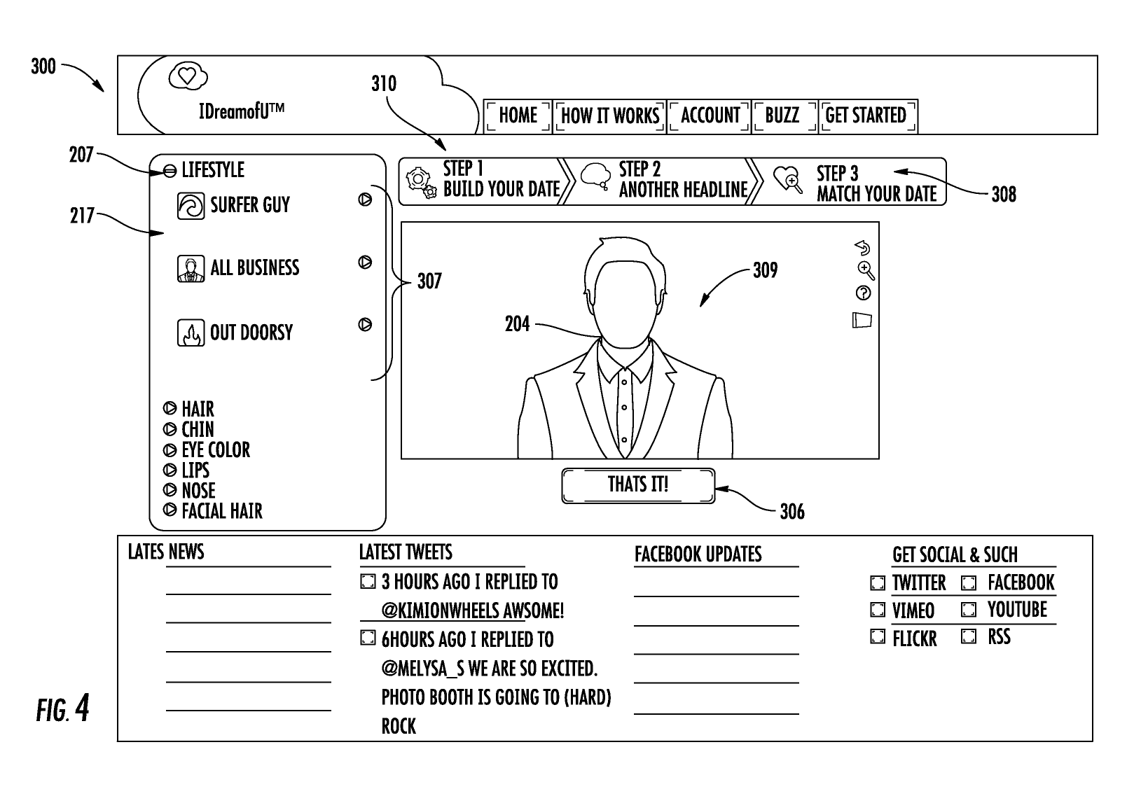

FIG. 4 illustrates an embodiment of the build from scratch option's web-page 300. In this embodiment, the user is presented with a baseline facial structure 204 to begin building a near-lifelike image. On the left frame of the browser screen, the user is presented with multiple feature categories 207, such as hair, chin, eye color, lips, nose, facial hair or the like. The user is then able to specify a feature parts 217 preference within each feature category 207. As the user is specifying the preferred feature parts 217, a preview image 309 is simultaneously being modified based upon user selection and displayed for the user. After reviewing the preview image 309, the user may click on a command button labeled that's-it 306 to complete the process of building the near-lifelike dream image.

The method also permits the user to review and select additional feature parts from the database. These additional feature parts are stored in a memory and displayed on a user device. A second created image is generated based on the additional feature parts selected by the user then the second created image is compared with the real images of other users. A second set of real images similar to the second created image is determined and displayed to the user on the user device.

In an alternative embodiment of the build from scratch feature, the user may be presented with a library of facial shapes, facial features and body types for selection. The user then selects a setting for the individual, such as hiking or presenting at a meeting, which best depicts the dream's favored lifestyle. Furthermore, the user may utilize the navigation bar 310 to initiate a request for matching 308 the near-lifelike dream preview image 309 with images of other user members on the website.

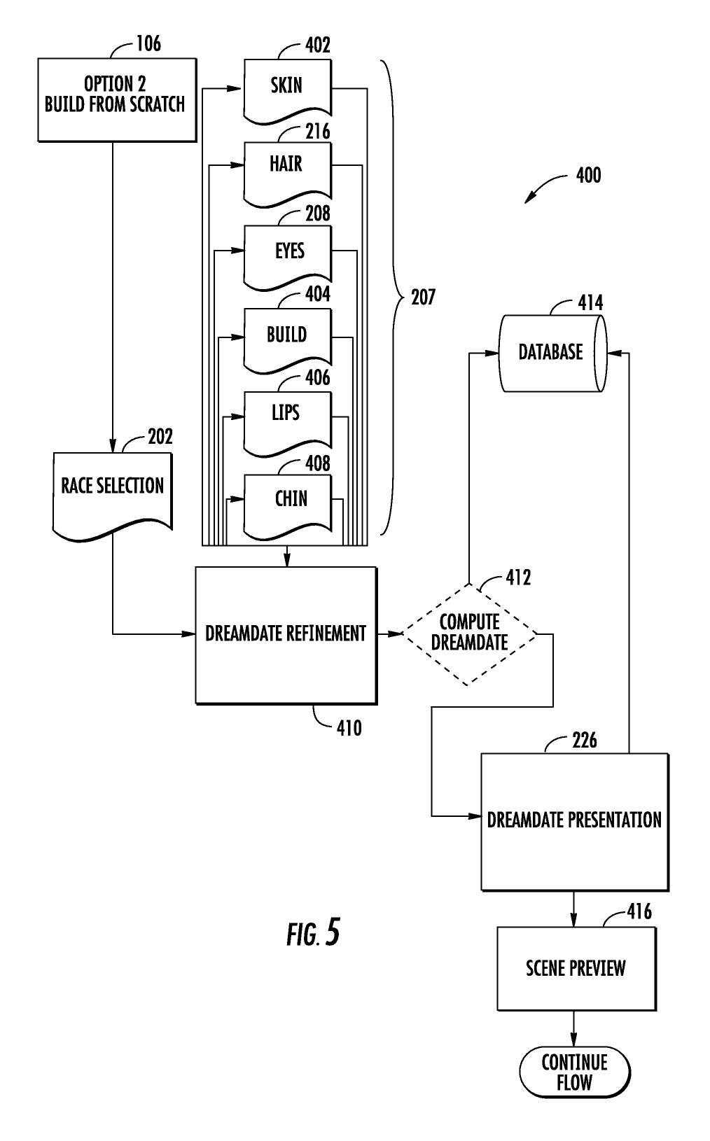

FIG. 5 shows the overview process flowchart for an embodiment of the build from scratch feature. In this embodiment, a user creates an image for a person of their dreams by utilizing a predefined step-by-step process on the website. The process 106 begins at step 202 by allowing a user to select a race. At step 410, the dream-date refinement module allows the user to select from multiple feature categories 207 such as skin 402, hair 216, eyes 208, build 404, lips 406, chin 408 and the like, and to select preferred feature parts in each feature category. The feature parts selected by the user are then processed by the dream-date refinement module at step 410 for computation and analysis.

At step 412, the compute dream-date module utilizes a database to create a near-lifelike image. This image is displayed to the user on a user device at step 226 by the dream-date presentation module. At step 414, the dream-date image is stored in a database. Finally, at step 416, a scene preview module allows the user to adjust the setting around the image to best depict the user's favored lifestyle, dating type, or preferred first date for the dream image. The scene preview module allows the user to adjust the dream image to incorporate the desirable person in their environment. For example, a user who wants to find a rock star may select a rock concert as their setting for the dream image. Additional edits may be applied to the image, permitting a user to specify or modify the age of the dream image or other characteristics. After the user is satisfied with their dream image, it may be shared via social media tools. In one embodiment, the dream image may be posted on a social networking website such as Facebook, Twitter, MySpace or the like. In another embodiment, the dream image may be posted on a personal website for searching and to receiving matches independent of the system which created the dream image.

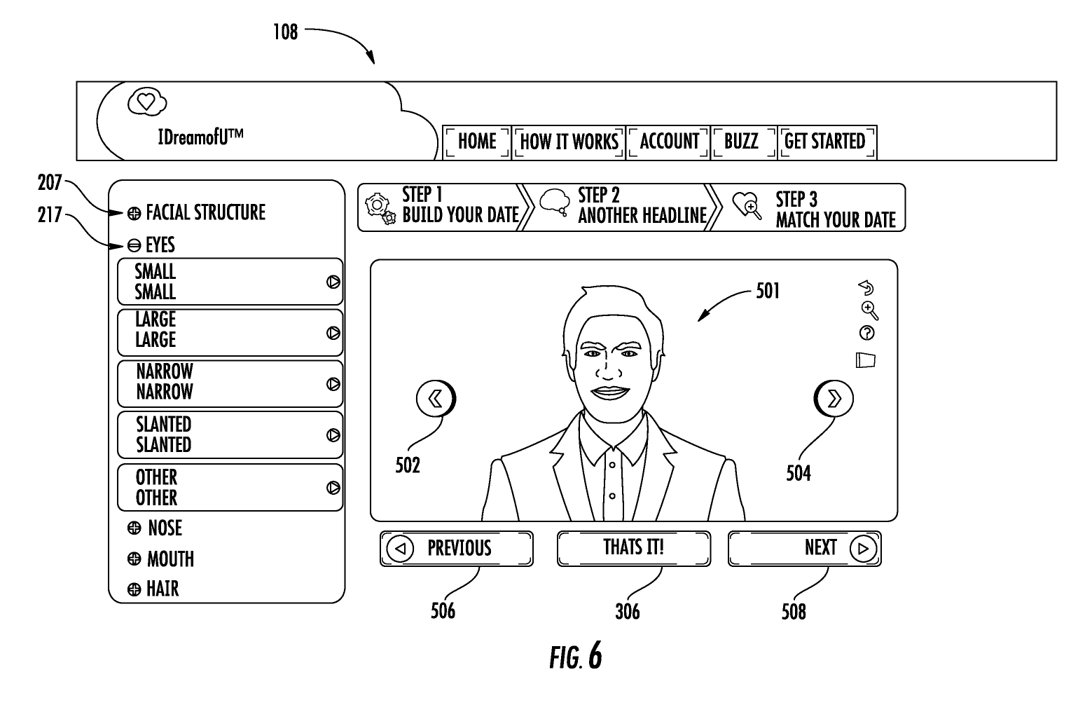

FIG. 6 depicts an embodiment of the everyday match feature 108. The process starts by allowing a user to select from a library of graphically created images of unknown people and to edit the facial and body features of a created image. In this embodiment, the user previews and selects a preferred image to begin with. The user then makes alterations by selecting from available filters. The user previews a library of stored graphically created images, for example image 501. The user may then navigate on a right side of the example image 504 or navigate on the left side of the example image 502 to select a preferred image, which is stored in the database of graphically created images. The database is stored in a memory and located remotely. Alternatively, a user may be permitted to utilize a previous image command button 506 or a next image command button 508 to select a desired image from the database of graphically created images. Optionally, the desired image shown in the preview image 501 may be altered by the user by selecting a feature category button 207 (i.e. filters) and/or feature parts button 217 (i.e., sub-filters). After the user is satisfied with the edited version of the preview image 501, the user selects it as the dream image by use of the that's-it command button 306. When the user indicates a dream image, the system may automatically suggest to the user to either share the image by means of a social media tool or to look for other user members on the site that match the selected dream image.

In another embodiment, the everyday match feature 108 consists of a two-phase process for creating a dream image from scratch. In the two-phased approach, a user previews images 501 available for selection by utilizing navigations buttons, such as button 504 and button 502. The user indicates a preference to the image by selecting that's-it 306. Then, the user is redirected to a new web page where feature categories and feature parts are displayed and can be selected by the user to alter the desired image.

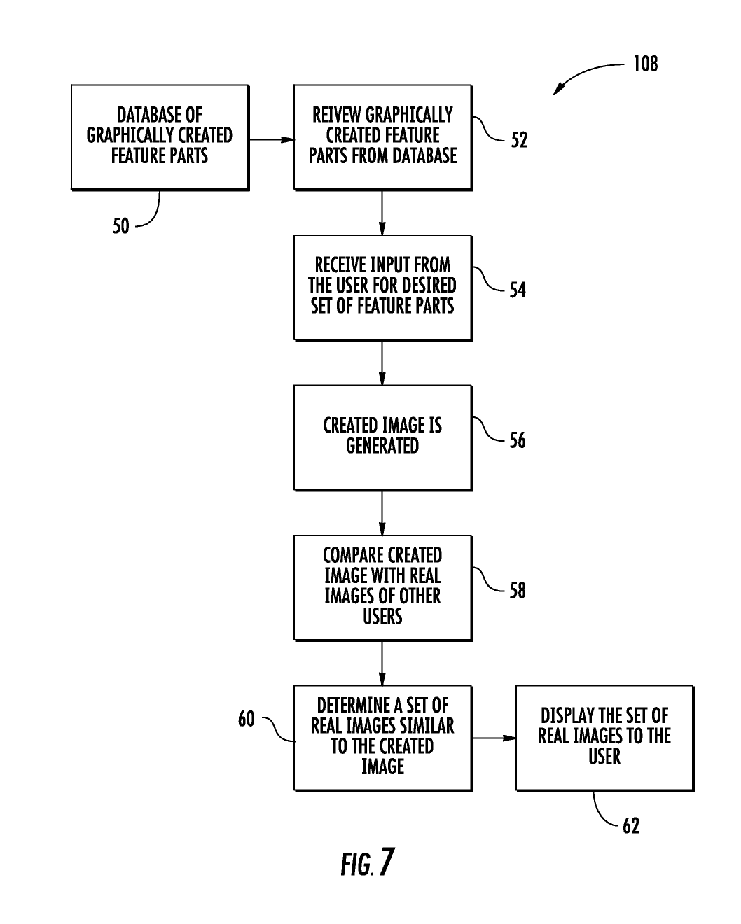

FIG. 7 is a flowchart for an overview for the everyday match feature 108. The method starts at step 50. Step 50 provides a database to store a plurality of graphically created feature parts in a memory. In one embodiment, the memory is located remotely. At step 52, the method permits a user to review the plurality of graphically created feature parts while the created feature parts are displayed on a user device. At step 54, an input is received from the user indicating a desired set of feature parts. A created image is generated based on the desired set of feature parts selected by the user at step 56. At step 58, the created image is compared with real images of other users. At step 60, a set of real images similar to the created image is determined. At step 62, the set of real images is displayed to the user on a user device.

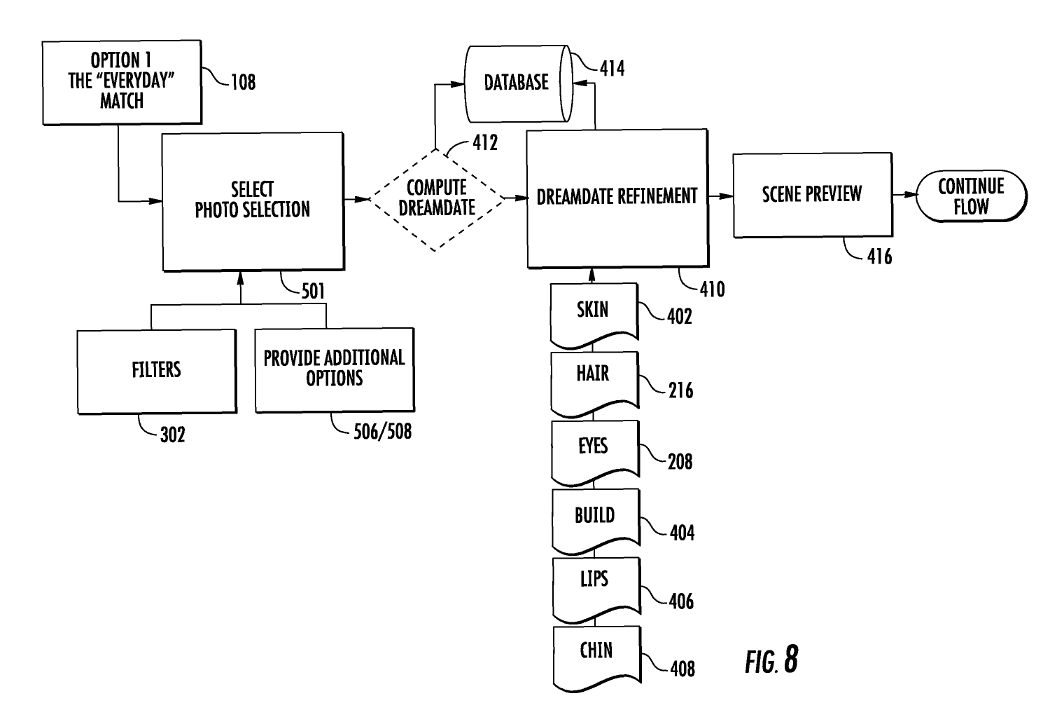

FIG. 8 is a process flowchart for an embodiment the everyday match option 108. The process starts at step 108. At step 501, a user views a displayed gallery of photos provided by a photo selection module. These photos are saved in a database of photos found in a memory which is located remotely. In addition, the gallery of photos presented may be based on indicators provided by the user at registration such as preferred gender, age, ethnicity, and the like. Alternatively, these preferences may be used as a filter during the matching process. After the user identifies an image of interest, the user refines the image by utilizing filters 302. The input received from the filters 302 and preference selections are sent to compute dream-date module at step 412. At step 414, the dream-date image is stored in a database. At step 410, the user is permitted to alter the dream-date, desired image by engaging the dream-date refinement module. This may be done by selecting feature categories such as, skin 402, hair 216, eyes 208, build 404, lips 406, and chin 408, and by refining the feature parts.

When the refinement is complete, the user previews and edits scenes at step 416. Again, the scene selection module provides the desired person in their environment, such as hiking or presenting at a meeting. Upon completion of building the dream image and optionally adding a scene, environment or background, the user may share by means of social media tools and platforms, such as posting on a Facebook wall, or sending the image out via Twitter. The desired image may be posted internally on the website for searching and matching with internal website users as well.

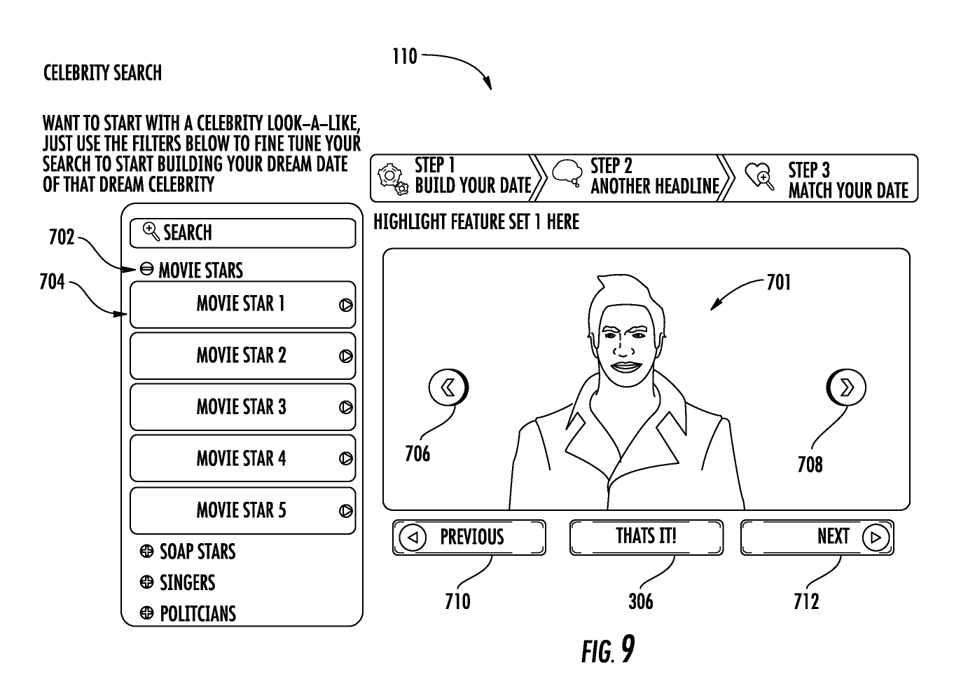

FIG. 9 illustrates an embodiment of the celebrity match feature 110. In this embodiment, the user selects a graphically recreated image of a celebrity (e.g., an actor or singer) to use as a base to create a dream image from. In an alternative embodiment, an almost famous feature may replace the celebrity match feature. In this embodiment, a user may select an image from a library of stored images, in a process similar to or the same as that described in the everyday match feature. The user may then edit the image by selecting from a plurality of feature parts, again in a process similar to or the same as that described in the everyday match feature. After a base celebrity image (or almost famous image in the alternative embodiment) has been chosen by a user, the user may then be able to use the library of available image filters 702 and image sub-filters 704 to make alterations to the desired image. The user may simultaneously preview the desired image 701 when altering based on image filters 702 or image sub-filters 704. In addition, the user may utilize navigation commands to the left of the preview image 706 and right of the preview image 708 to preview different images available in the library of available images, or image database. Alternatively, the user may utilize navigation commands previous 710 and next 712 to preview different images available in the library of available images, or image database. The user may indicate a preference for an image of a dream by selecting that's-it command button 306. A user may further refine their dream image by utilizing feature categories and feature parts.

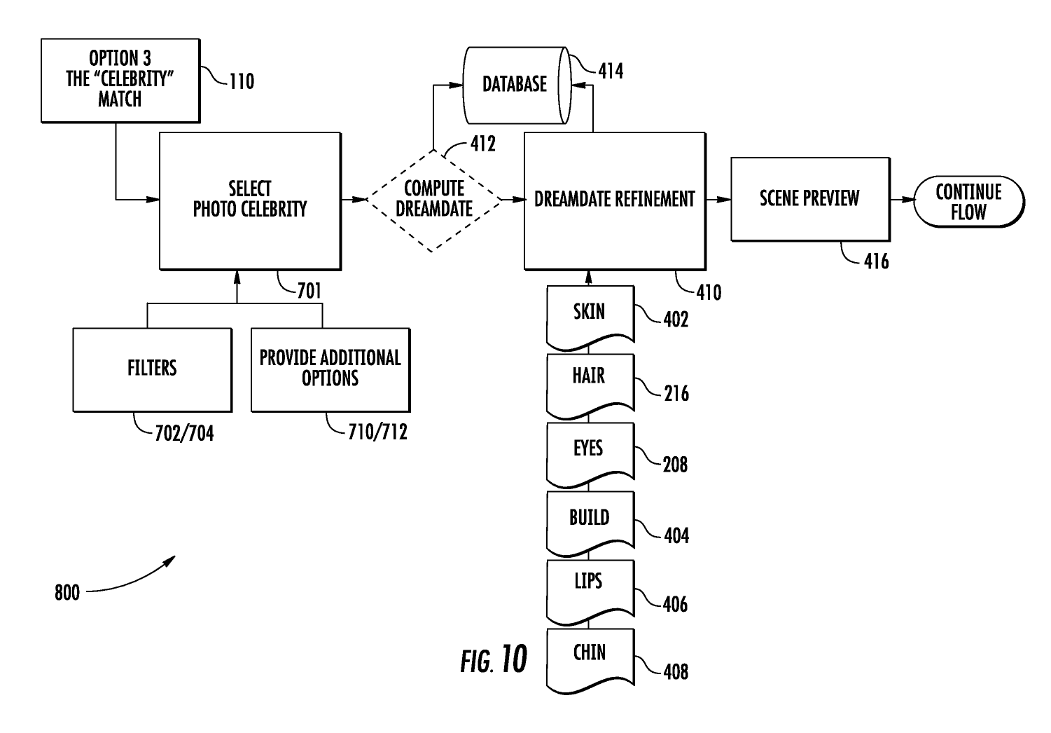

FIG. 10 depicts a process flowchart for an embodiment utilizing the celebrity match feature 110. The process 800 begins at step 110. At step 701, a user selects a photo of a celebrity. The photo is then refined by utilizing image filters at step 702 and image sub-filters at step 704. Steps 412 and 414 are described above. At step 410 the dream-date refinement module is used to refine the image by utilizing feature categories and feature parts as set forth above. Again, the user may be permitted to select a setting via the scene preview module at step 416. The final dream image may be utilized as described above.

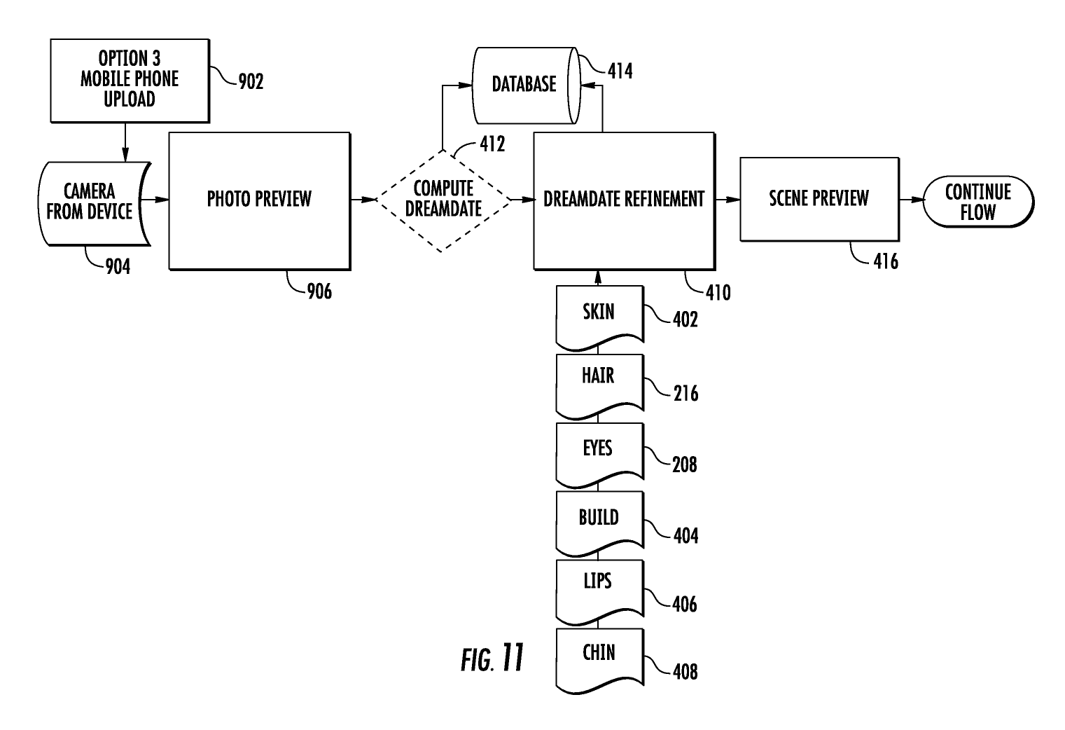

FIG. 11 details an embodiment of a mobile application for an image upload feature. In this embodiment, the mobile application allows a user to download a version of the website implemented system onto a mobile device. This enables the user to create a dream image either (i) from an existing image on the mobile device or (ii) by accessing alternative means available on a related website (such as via everyday match, build from scratch, or celebrity match) as described above.

In one embodiment, the mobile application permits a user to select an image in the image library of the mobile device. In this embodiment, the image library contains images of pictures captured by the camera integrated into the mobile device or images that have been downloaded onto the mobile device. The selected image is then uploaded to the associated website and onto the user's account. The image is then processed as set forth above to create the visual representation of the selected image for the purpose of matching its facial and surrounding characteristics with other user's photographs.

In one embodiment, when the photograph or an image of a person from the mobile device is received by the web/application server of the website, the image is deconstructed into a plurality of feature parts. Then the feature parts of the deconstructed image are associated to respective feature categories and feature parts in the database. The real feature parts are used as inputs for making the graphically created feature parts. Once the photograph is successfully uploaded to the user's account, the user will be permitted to view the graphically re-created image of the original image that was uploaded. If the user is satisfied with the image as displayed, the user may elect to apply filtering using the dream-date refinement module described above. A dream image may then be computed by the above-described dream-date module. The final created dream image may be referred to as a final variation. The user may use the final variation to initiate a request to find photographs of existing users on the website that match or substantially match the dream image for dating or meeting purposes. The user may also post the dream image on a social networking site for others to view or for others to provide feedback.

In one embodiment, the mobile application will be an iPhone, Android or other PDA application available for download by a user. In another embodiment, the mobile application will allow a user to establish and maintain account information, as well as communicate with others.

The process of FIG. 11 begins at step 902. At step 904, an image is provided by the camera on the mobile device. At step 906, the image from the camera is displayed for the user. The next steps mimic the steps already described above.

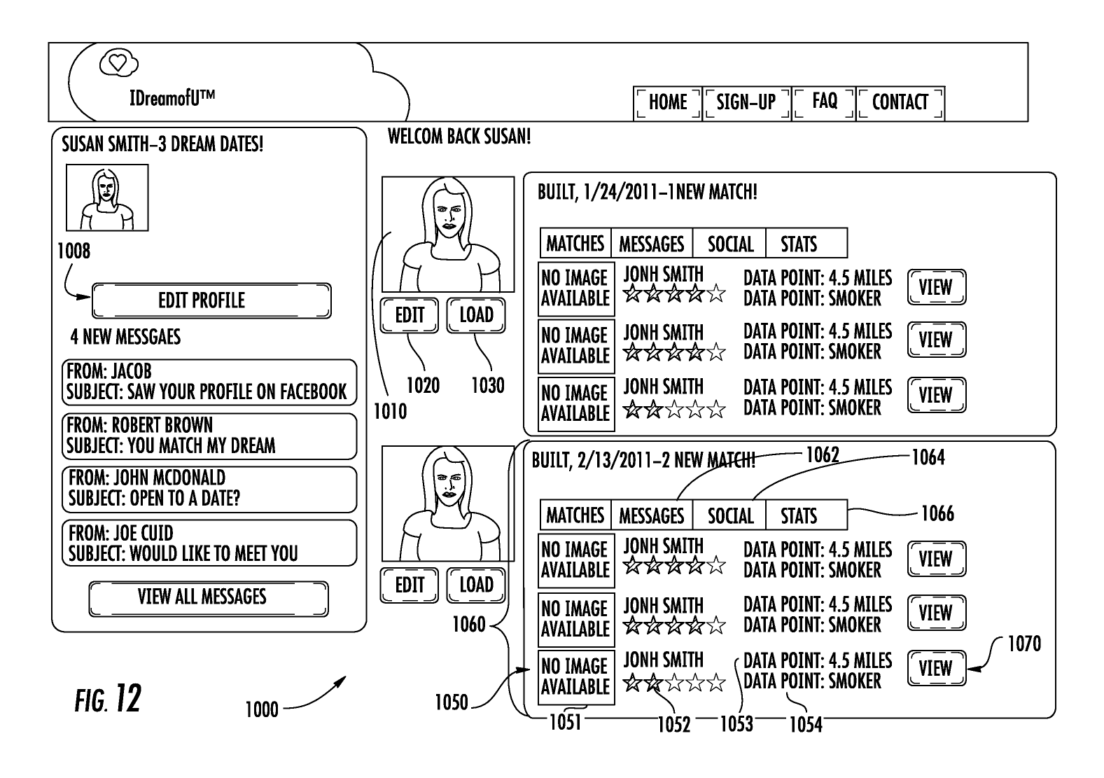

FIG. 12 shows an embodiment of the dashboard for the matching module. In this embodiment, the match dashboard 1000 is a location where the dream images created by the user are displayed on a user device. The match dashboard 1000 may be used for matching the dream image with photos of other user members, and for displaying those other user matched members for meeting or dating purposes. The created image, which is near-lifelike, is compared with real images of other users. A set of real images, similar to the created image, is determined and displayed to the user on a user device. For each dream image, the match dashboard 1000 displays a listing of possible match images along with information related to how close the match image is to the dream image. User profile characteristics identified during the account registration phase may also be displayed on this dashboard 1000.

The match dashboard 1000 includes a preview image 1010 of the final variation or dream image. Within the match dashboard 1000, a user will be permitted to edit 1020 the final variation or dream image. Within the match dashboard 1000, a user is permitted to load 1030 the final variation or dream image. Furthermore, for each dream image that is submitted for matching, a listing of possible matches 1060 is displayed on a user device. Each match profile 1050 includes a thumb-nail image 1051 of the other user, a star rating 1052 to show how similar the match is, location distance from the other user 1053, and a smoking preference indicator 1054. The star rating 1052 is derived utilizing known techniques in applying statistical analysis to determine similarity between the dream image and the resulting member image. Other items may be displayed here as customized by the user. The user may view all messages associated with other users clicking a messages button 1062. Optionally, the user may share this dream image with others by means of a social media tool by clicking the Social button 1064. Optionally, the user may view statistics related to this dream image by clicking the Stats button 1066.

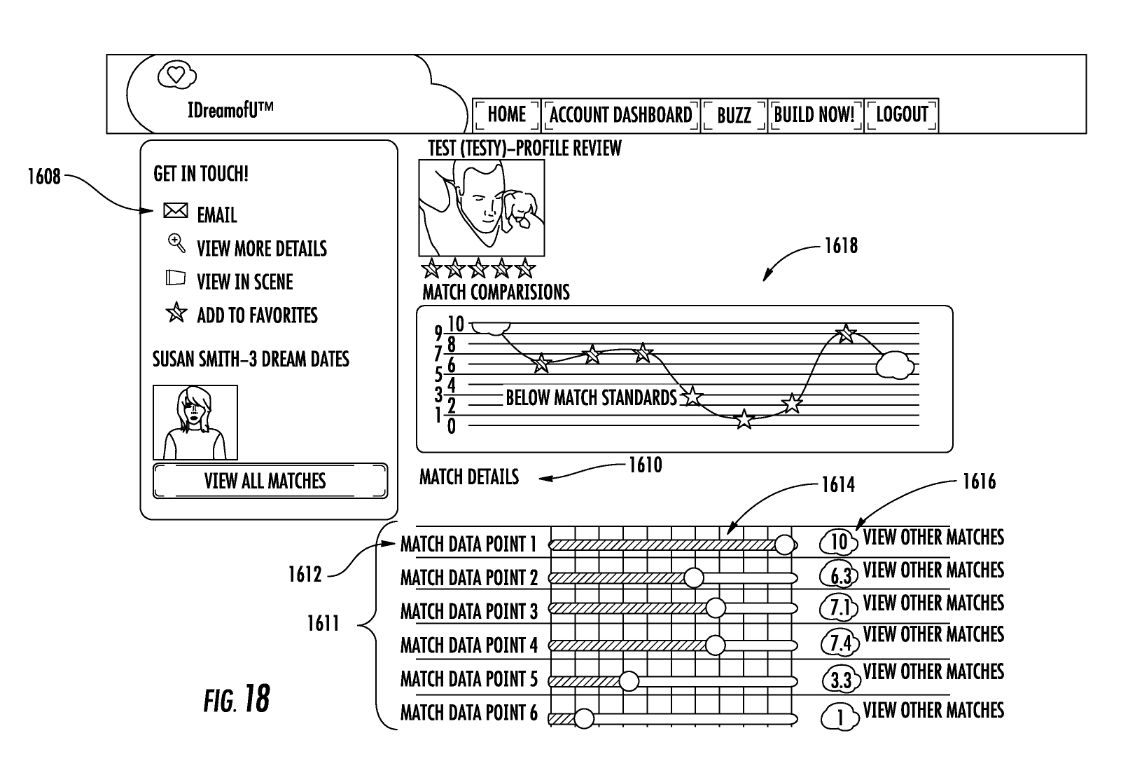

The set of real images of other users displayed on a user device may facilitate a user to contact other users. For example, a user may contact one of the other users, the one of the other users being associated with a real image in the set of real images. Referring to FIG. 18, in one embodiment, the user may click email button 1608. A pop-up window, for example, allows a user to type a message to the other user then submit it for delivery. If a user receives a message from another user, the user is notified by referring to FIG. 12, new messages button 1008. This notification may be by a symbol (or other visual notification) or audio sound.

When a user clicks on new messages button 1008, all received messages are listed. The user can then click on each message individually to view the content. In one embodiment, all actual email addresses associated with the user's account remain hidden from other users and messages are only sent and received through the method of the present invention. In another embodiment, messages may be sent and received through a third party.

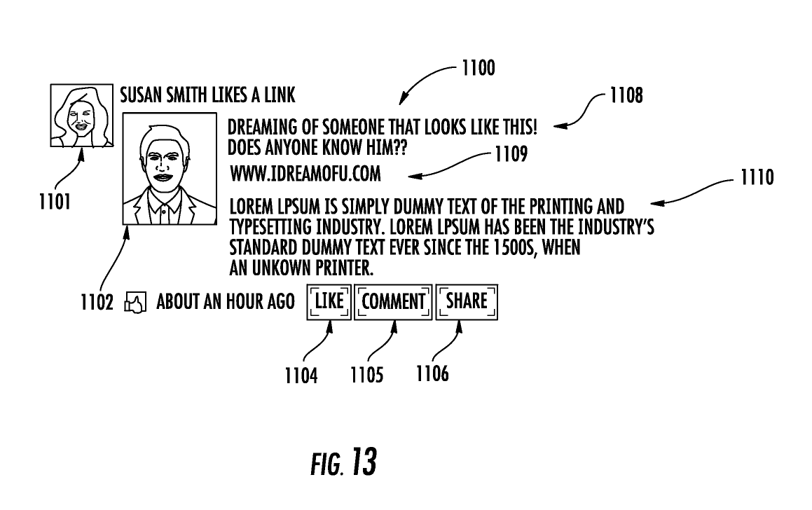

Moreover, each match profile 1050 is described in more detail if a user selects the View Details button 1070. FIG. 13 depicts an example of social posting. In one embodiment, once a dream image is created, the dream image can be sent out via a social media tool to friends or posted on a website for a possible match. In another embodiment, after the dream image is created, the user may post the dream image to their Facebook or other social networking account. The user may then request that friends notify them if they recognize anyone who resembles the dream image. In an alternative embodiment, the dream image may be transmitted to others via Twitter for followers to recommend a possible match. In addition, with every social networking post and with every Twitter tweet or other distribution, advertising for the social media website may be provided. In another embodiment, the user is requested to post their dream image on the website for potential matching. FIG. 13 is an illustrative depiction of a user posting a dream image on Facebook. The posting may include (i) an image of the user posting the dream image 1101, a status update 1108 associated with the posting, a link to the website that created the dream image 1109, additional comments by the user 1110, the dream image 1102, and link buttons to like 1104, comment 1105, and share 1106. Link buttons 1104, 1105 and 1106 may be used by others to initiate communication with the user.

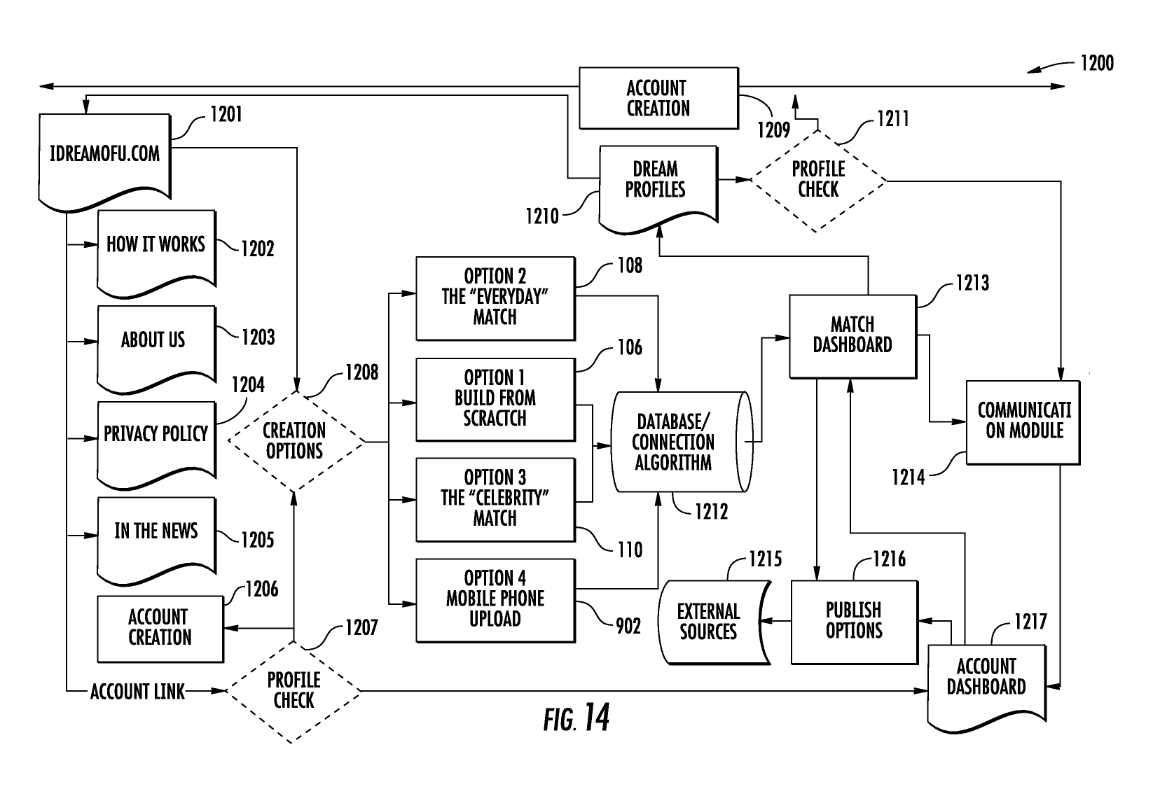

FIG. 14 shows an embodiment of a sitemap 1200 for the website. The sitemap is a block diagram describing various features within the website as well as relationships or links between the various features. As depicted in sitemap 1200, the user may access the website at 1201. The user is presented with multiple options. In one option the user may select the how it works tab 1202 and be presented with a video to see how the site works. The user may select an about us tab 1203 to receive information about the company providing the website. The user may select the in the news tab 1205 which provides links to news articles. The website's privacy policy tab 1204 describes the relevant legal policies for website use.

The user may access their account via an account login or profile check 1207. The profile check permits the user to access their account dashboard to review dream profiles 1210 and match dashboard 1213. Upon account creation 1206 or account login 1207, a user is able to create a dream image by utilizing various available methods. The methods (aka modules) to create the dream image include, build from scratch 106, everyday match 108, celebrity match 110, and mobile phone upload 902. In this embodiment, the user may employ a tab to facilitate account creating 1209 during anytime while accessing the website.

In one embodiment, the user may select creation option 1208 to create a dream image by using one of the four methods provided by the site. A database and connection algorithm 1212 may be used to generate the dream image. The dream image is displayed on the match dashboard 1213. The match dashboard 1213 permits a user to view their previously created dream images, edit the previously created dream images, communicate their previously created dream images via the communication module 1214, review or edit their dream profile 1210, and/or publish 1216 their previously created dream images to external sources 1215 (e.g., Facebook and/or Twitter). Also, the user may access their account 1207 and be directed to their account dashboard 1217 where they are permitted to publish their previously created dream images. Account preferences may be provided at dream profiles 1210, and these preferences may include, for example, sexual preference, geographic location, body build, and age. The preferences may be optionally used as search criteria as a means to filter match results.

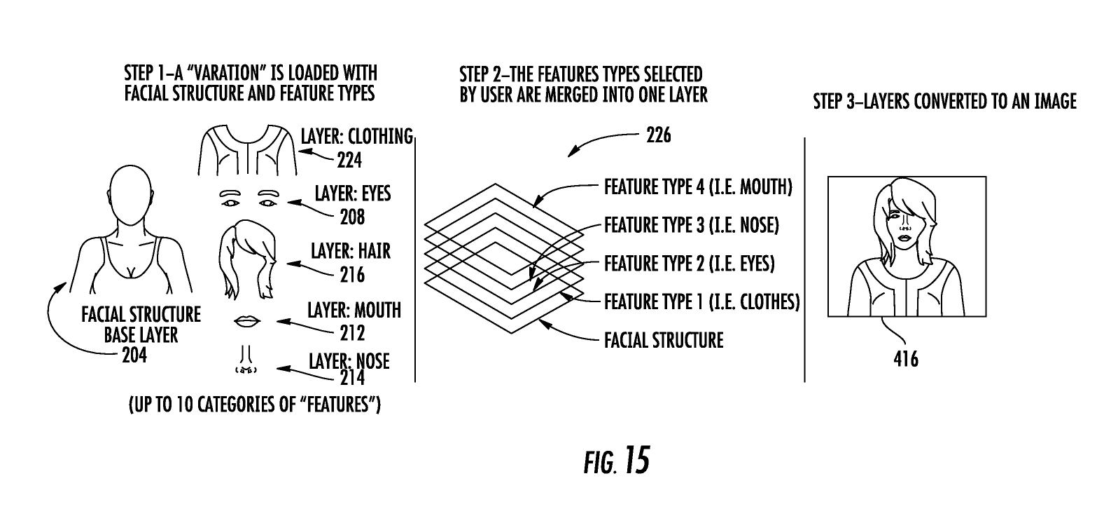

FIG. 15 is a diagram of an example process for creating a dream image. In this example, a variation image is loaded with facial structure 204 as selected by a user along with feature categories clothing 224, eyes 208, hair 216, mouth 212 and nose 214. The feature parts are selected by the user from each of the available feature categories and are merged into a single layer 226 with the facial structure as the base layer. The layers are then converted into a dream image 416.

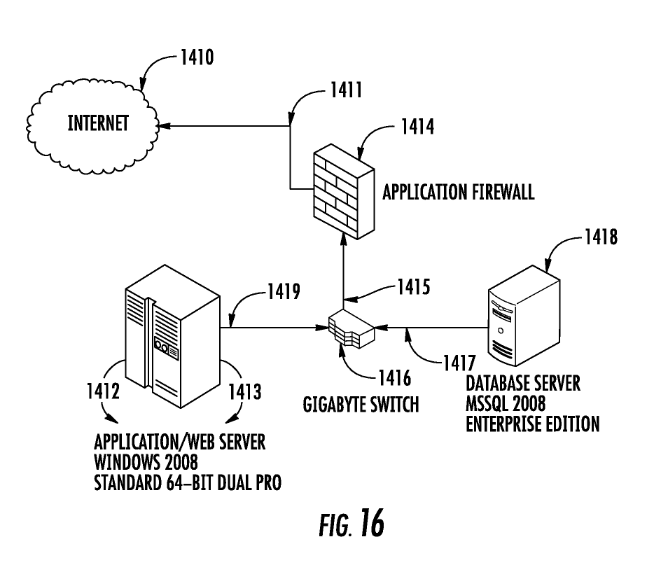

FIG. 16 illustrates an embodiment of the hardware configuration supporting the website. The hardware configuration may include an application server 1412, a web server 1413, a gigabyte switch 1416, a database server 1418, and an application firewall 1414.

As shown in FIG. 16, the application/web server 1412, 1413 may be located in the same device and are in communication with Gigabyte switch 1416 via a wired or wireless communication link 1419. The Gigabyte switch 1416 is in communication via a wired or wireless communication link 1417 to the database server 1418. The Gigabyte switch 1416 is in communication via a wired or wireless communication link 1415 to the application firewall 1414. The application firewall 1414 is in communication via a wired or wireless communication link 1411 to the internet 1410.

In one embodiment of the present invention, the hardware configuration may be physically hosted as depicted in FIG. 16. In another embodiment, the hardware configuration may be hosted by cloud computing to provide for delivery of computing as a service rather than a product. Such cloud computing may utilize hardware resources from multiple, unrelated physical locations. Shared resources (e.g., Application/Web servers, Database servers), software, and related information may be provided to a device such as a computer, laptop, Mac, PC, mobile phone, personal digital assistant (PDA), smartphone, iPhone, Blackberry, Android system, Palm device, netbook, smartbook, tablet, broadband device, or any other device that connects to a carrier, as a utility over a network, typically the Internet.

The application/web server 1412, 1413 may be, for example, a standard 64-bit dual processor running Windows 2008 and Coldfusion 9. The database server 1418 may be, for example, a standard 64-bit dual processor running Windows 2008 and MSSQL 2008.

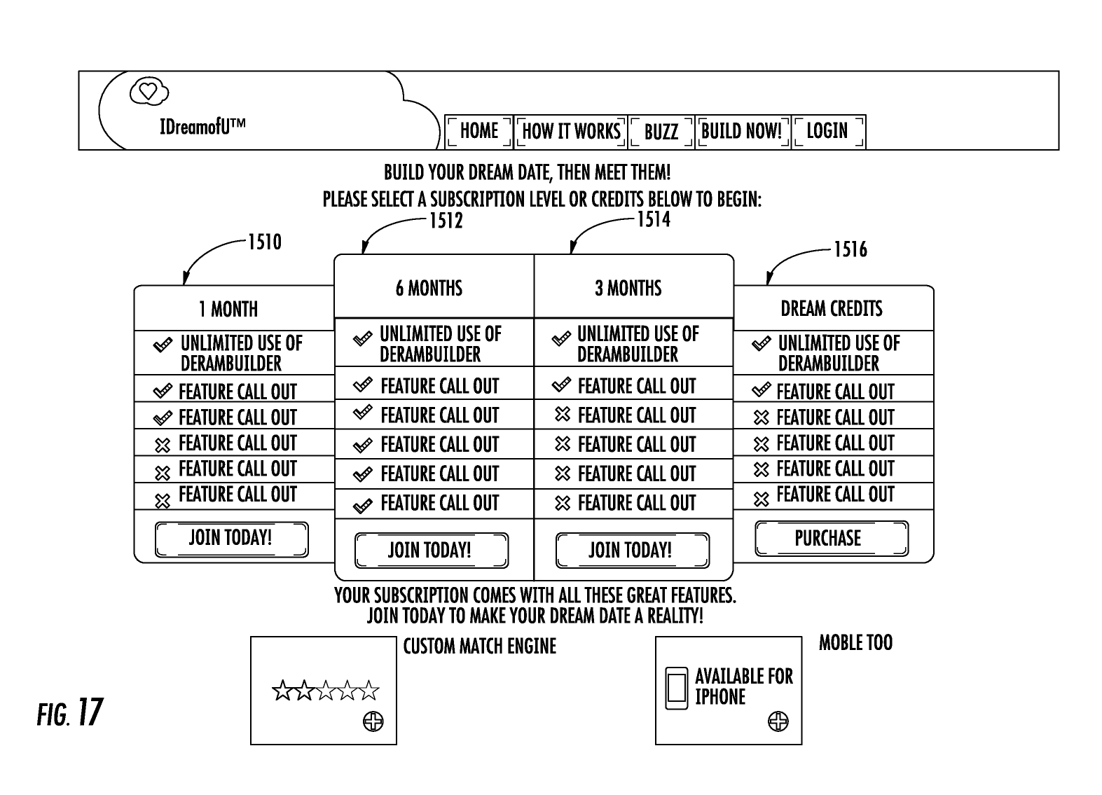

FIG. 17 depicts example subscription service plans. In one embodiment, a user of the website may purchase a plan for 1 month duration 1510, so that the user is permitted to create an unlimited number of variations, or dream images, using the dream builder technology. In another embodiment, a user of the website may purchase a plan for 6 months duration 1512, so that the user is permitted to create an unlimited number of variations, or dream images, using the dream builder technology. In another embodiment, a user of the website may purchase a plan for 3 months duration 1514, so that the user is permitted to create an unlimited number of variations, or dream images, using the dream builder technology. In an alternative embodiment, a user of the website may purchase dream credits 1516 for a fixed fee for each dream image they desire to post by means of social media tools or other external sources. Dream credits 1516 may also be used to contact other user members that match the dream image which are displayed on the dream dashboard. In yet another embodiment, a user may create their profile, dream image, and account, but not subscribe, wherein monthly subscription or dream dollars credit is not required unless a user desires to communicate with others users on the site or post a dream image on a social media website.

FIG. 18 shows one embodiment of a detailed view of a member match. In this embodiment, match details 1610 are depicted in a table format comprising a list of multiple profile characteristics 1611 of the match. Characteristics 1611 may be presented in a horizontal bar graph 1614 and a total match score 1616 corresponding to each profile characteristic 1612 may be presented to the user. Alternatively, a match comparison graph 1618 may be displayed to the user on a user device to illustrate each of the profile characteristics 1612 and their associated total match score 1616.

In an alternative embodiment, a method of matching lifelike feature parts to find desirable images is provided. Similar to already disclosed embodiments, this embodiment begins with a first user builds a near-lifelike image of a person of interest by selecting feature parts. For example, the first user may start by selecting a base facial structure from a library located in a memory of available facial features. Additional features may then be selected by the first user to build a lifelike face for the desired image, which may be displayed for the first user to review and update. Therefore, while the first user is selecting the plurality of feature parts, a dream builder software engine generates a preview image for the first user. This preview image may be displayed to the user on a user device during feature parts selection to assist with creating the desired image. Optionally, the first user may also customize the lifelike image by selecting a plurality of feature parts associated with parts of the human body such as clothing or human upper body parts. In this example, a database is created to store the feature parts in a memory.

A second user also builds a near-lifelike image, but this image is usually a depiction of himself or herself so that he/she may be found by the first user. Similar to the first user, the second user starts by selecting a base facial structure from a library located in a memory of available facial features. Then, the second user adds more features and customizes the lifelike image. The same database or another database stores the feature parts associated with the second image in the same or a different memory. Simultaneously, while the second user is selecting the plurality of feature parts, a dream builder software engine generates the second user's preview image. This second preview image may be displayed to the user on a user device during feature parts selection to assist with creating the image.

Other users follow the same process as the second user to assist with creating a database of available images for searching. It's desirable to have many other users create images that look like themselves which may be searched by the first user. In one example, the second user being searched doesn't create a near lifelike image of himself or herself. Instead, only feature parts are selected by the second user which may be searched by the first user. Thus, feature parts selected by the first user are compared to feature parts selected by the second user (and other users). In this example, the only image generated is the desirable one created by the first user selecting feature parts.

After the first user has completed a first desired image, the first user may make a request for matching. The feature parts of the first user's created image are then compared with feature parts of the available images for searching provided by other users. The software then finds images with the most matching feature parts to generate a set of real images of other users. The set of real images of other users is then displayed to the first user on the first user's display device.

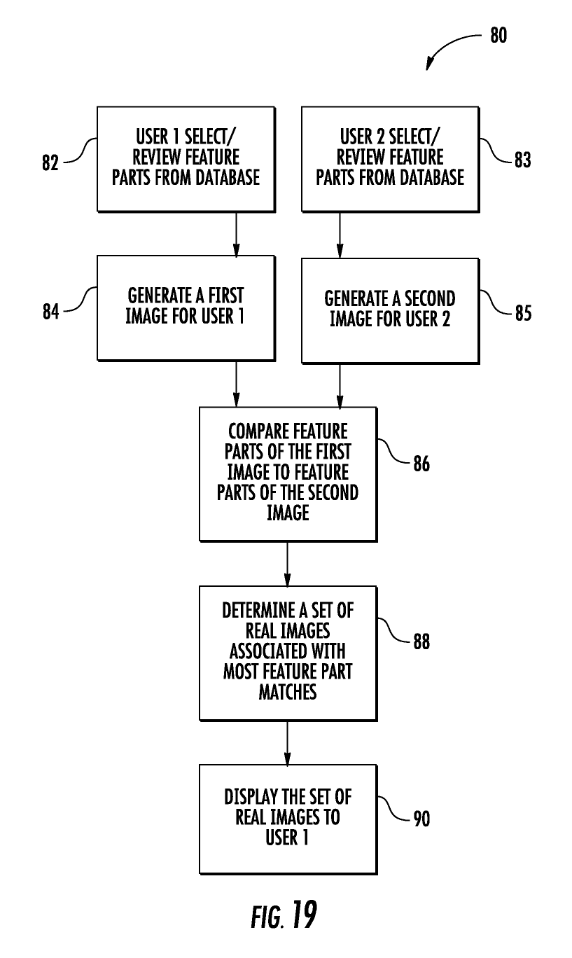

FIG. 19 is a process flowchart for the alternate embodiment of matching lifelike (e.g., avatar) images to feature parts 80. The process starts at step 82, where a first user, or user1, reviews and selects a plurality of feature parts from a database located in a memory containing feature parts. At step 84, a created image for the first user is generated based on the plurality of feature parts selected by the first user. At step 83, a second user, or user 2, reviews and selects a plurality of feature parts from a database located in a memory containing feature parts. At step 85, a created image for the second user is generated based on the plurality of feature parts selected by the second user. The created image for the first user is compared to the created image for the second user at step 86. At step 88, a set of real images with the highest amount of feature part matches is determined. The set of real images is displayed to the user on a user device at step 90.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention. Thus, it is intended that the present subject matter covers such modifications and variations as come within the scope of the appended claims and their equivalents.

The invention claimed is:

1. A method of matching based on a created image, the method comprising the steps of:
permitting a user to review and select a plurality of feature parts from a database containing feature parts, the feature parts being stored in a memory and displayed on a user device;
generating the created image based upon the plurality of feature parts selected by the user;
comparing the created image with real images of other users;
determining a set of real images similar to the created image; and
displaying the set of real images to the user on the user device.

2. The method of matching based on a created image of claim 1, wherein the created image is near-lifelike.

3. The method of matching based on a created image of claim 1, further comprising the step of:
prompting the user to select a facial structure.

4. The method of matching based on a created image of claim 1, further comprising the step of:
facilitating the publishing of the created image.

5. The method of matching based on a created image of claim 4, wherein the publishing is to an external social networking website.

6. The method of matching based on a created image of claim 1, further comprising the step of:
facilitating contact between the user and one of the other users, the one of the other users being associated with a real image in the set of real images.

7. The method of matching based on a created image of claim 1, wherein the feature parts are associated with parts of a human body.

8. The method of matching based on a created image of claim 1, further comprising the steps of:
permitting the user to review and select additional feature parts from the database, the additional feature parts being stored in a memory and displayed on a user device;
generating a second created image based on the additional feature parts selected by the user;
comparing the second created image with the real images of other users;
determining a second set of real images similar to the second created image; and
displaying the second set of real images to the user on the user device.

9. The method of matching based on a created image of claim 1, wherein the memory is located remotely.

10. The method of matching based on a created image of claim 1, further comprising the steps of:
receiving an image of a person;
deconstructing the image of a person into a plurality of real feature parts; and
using the real feature parts as inputs for making the graphically created feature parts.

11. A method of matching based on a created image, the method comprising the steps of:
providing a database to store a plurality of graphically created feature parts;
permitting a user to review the plurality of graphically created feature parts while the created feature parts are displayed on a user device;
receiving an input from the user indicating a desired set of the feature parts;
generating a created image based on the desired set of the feature parts;
comparing the created image with real images of other users;
determining a set of real images similar to the created image; and
displaying the set of real images to the user on the user device.

12. The method of matching based on a created image of claim 11, wherein the created image is near-lifelike.

13. The method of matching based on a created image of claim 11 wherein the feature parts are associated with parts of a human body.

14. The method of matching based on a created image of claim 11, further comprising the step of:
storing the feature parts in a memory.

15. The method of matching based on a created image of claim 14, wherein the memory is located remotely.

16. The method of matching based on a created image of claim 11, further comprising the step of:
facilitating the publishing of the created image.

17. The method of matching based on a created image of claim 16, wherein the publishing is to an external social networking website.

18. The method of matching based on a created image of claim 11, further comprising the step of:
facilitating contact between the user and one of the other users, the one of the other users being associated with a real image in the set of real images.

19. The method of matching based on a created image of claim 11, further comprising the steps of:
receiving an image of a person;
deconstructing the image of a person into a plurality of real feature parts; and
using the real feature parts as inputs for making the graphically created feature parts.
